(19) United States
(12) Patent Application Publication
(10) Pub. No.: US 2005/0171329 A1
(43) Pub. Date: Aug. 4, 2005

(54) Recording material

(76) Inventors: Hiroshi Enomoto, Saitama (JP); Sayuri Imaizumi, Saitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/033,124

(22) Filed: Jan. 12, 2005

(30) Foreign Application Priority Data
Jan. 30, 2004 (JP) 2004-023407

(51) Int. Cl. C08G 63/08

(52) U.S. Cl. 528/354

(57) ABSTRACT

Provided is a recording material which is improved in an adhesive property between a recording layer and a base material and is excellent in a printing aptitude in a heat transfer recording system or an ink jet recording system, a writing property and a stamp property and which can contribute to waste problems continuing to grow large and is excellent in a biodegradability. The above recording material has a recording layer formed by coating a coating solution containing a biodegradable resin comprising a non-crystalline polylactic acid resin and a filler on at least one face of a base material comprising a crystalline biodegradable polylactic acid resin, wherein a solvent used for the coating solution is a solvent having a solubility parameter of 7.5 to 12.5 (cal/cm³)^{1/2}, and a content of the above solvent in the coating solution is 40 to 90 mass %; and the above solvent contains 20 mass % or more of a solvent having a relative dielectric constant of 15 or more.

### BACKGROUND OF THE INVENTION

The present invention relates to a biodegradable recording material, more specifically to a recording material having an excellent biodegradability provided on at least one face of a biodegradable substrate with a biodegradable recording layer which is excellent in an adhesive property with the above substrate as well as a printing aptitude in general printing and which is improved in a printing aptitude in a heat transfer recording system and an ink jet recording system.

### RELATED ART

In recent years, a plastic film is used for a recording material represented by an ink jet recording paper and a heat transfer recording paper in uses in which required are a strength, a water resistance and a smooth image making the best use of a smooth surface and a transparency in OHP as personal computers and the like spread, and a disposal amount of the above information-recording material is increasing year by year. A large part of disposed information-recording material is occupied by plastic products, and they have provided a problem as materials which are very difficult to dispose particularly because of the characteristic that they are not semipermanently decomposed.

Also, they can be subjected to burning treatment, but plastic products have high combustion calorie and exert a load onto a combustion furnace, and in addition thereto, they are likely to cause generation of dioxin depending on the kind of the plastics.

The above matters have raised concerns about environmental problems, so that products making use of materials having a biodegradability are under active development. These biodegradable materials are finally decomposed into water and carbon dioxide by microorganisms and enzymes, and therefore a load exerted on the environment is reduced to a large extent.

Among these biodegradable materials, a polylactic acid resin originating in plants such as corn, starch and the like attracts attentions as a material having almost the same characteristic as that of a polyethylene resin, and it is investigated a lot in the recording material field as a resin used for a base material and a recoding layer.

Proposed is, for example, “a coating having good coating film physical properties formed from a biodegradable polyester which contains 70 to 100 mole % of a lactic acid residue and has a crystallinity of a mole ratio (L/D) of 5.0 to 19.0 in terms of L-lactic acid to D-lactic acid and in which melting heat is observed” {refer to a patent document 1: Japanese Patent Application Laid-Open No. 204378/1998(heisei 10)}.

Also, proposed is “an ink jet recording medium in which a base material is a polylactic acid film and in which an anchor coating layer for an ink-receiving layer comprising polylactic acid soluble in an organic solvent and an ink-receiving layer are formed in this order on the base material” {refer to a patent document 2: Japanese Patent Application Laid-Open-No. 321072/1999 (heisei 11)}.

Further, proposed is “a printing film obtained by co-extruding a crystallized lactic acid base polyester composition comprising polylactic acid and lactic acid base polyester and having a melting point of 120° C. or higher as a base material layer and a non-crystalline composition comprising polylactic acid and lactic acid base polyester and having a softening point of 40 to 110° C. as an ink-receiving layer” (refer to a patent document 3: Japanese Patent Application Laid-Open No. 94586/2003).

Also, proposed is an example in which “coated on a polylactic acid film is a biodegradable resin composition improved in physical properties such as a flexibility, a tenacity and a solvent resistance which is obtained by dissolving an aliphatic polyester resin and an isocyanate compound in a solvent, mixing them, coating resulted solution on a polylactic acid film, removing the solvent by drying and then curing the residue by heating” {refer to a patent document 4: Japanese Patent Application Laid-Open No. 251368/1998(heisei 10)}.

It is described that the base material used in the patent document 1 is a poly-L-lactic acid biaxially stretched film and that the base material used in the patent document 3 is a crystallized lactic acid base polyester composition comprising polylactic acid and lactic acid base polyester and having a melting point of 120° C. or higher, and a crystalline polylactic acid film is used as the base material. Also in the patent document 2 and the patent document 4, polylactic acid is used for the base material, but the crystallinity is not clearly described. However, as it is described in the patent document 2 that “a polylactic acid resin has usually a continuous unit of L-lactic acid as a structural unit and has a high crystallinity and that it is insoluble in conventional and general purpose organic solvents”, crystalline polylactic acid is used as the base material.

On the other hand, a non-crystalline polylactic acid resin which is soluble in general purpose organic solvents is used as a binder for a recording layer (including an ink-receiving layer).

As described above, a polylactic acid base resin is used for both of the base material and the recording layer, but crystalline polylactic acid used for the base material is insoluble in general purpose organic solvents, and therefore an adhesive property between the recording layer and the base material is not necessarily satisfactory. A halogen base organic solvent can be used in order to dissolve crystalline polylactic acid, but the halogen base organic solvent has a problem on the environment and therefore is not preferred.

A rise in an adhesive property between both described above is indispensable for providing a recording material which is soft to the environment owing to its excellent biodegradability and which has a good printing aptitude in a heat transfer recording system and an ink jet recording system, and it is desired to improve the adhesive property using a general purpose organic solvent without using a halogen base organic solvent which can dissolve a crystalline polylactic acid resin.

### DISCLOSURE OF THE INVENTION

An object of the present invention is to provide a recording material using a biodegradable resin for both of a base material and a recording layer, which is improved in an adhesive property between the base material and the recording layer formed by coating a general purpose organic solvent solution containing the biodegradable resin on the base material and is excellent in a printing aptitude in a heat transfer recording system or an ink jet recording system, a writing property and a stamp property and which can contribute to the solution of waste problems continuing to grow large owing to its excellent biodegradability.

Intensive researches repeated by the present inventors in order to achieve the object described above have resulted in finding that the object can be achieved by using a coating solution containing a specific amount range of a solvent having a specific solubility parameter (hereinafter referred to as an SP value) and containing therein a specific amount or more of a solvent having a specific relative dielectric constant as a solvent which dissolves a biodegradable resin used for a recording layer.

The present invention has been completed based on the above knowledge.

That is, the present invention provides:
(1) a recording material having a recording layer formed by coating a coating solution containing a biodegradable resin comprising a non-crystalline polylactic acid resin and a filler on at least one face of a base material comprising a crystalline biodegradable polylactic acid resin, wherein a solvent used for the coating solution is a solvent having an SP value of 7.5 to 12.5(cal/cm³)^{1/2}, and a content of the above solvent in the coating solution is 40 to 90 mass %; and the above solvent contains 20 mass % or more of a solvent having a relative dielectric constant of 15 or more,
(2) the recording material as described in the above item (1), wherein the filler is a natural inorganic and/or organic filler and
(3) the recording material as described in the above item (1) or (2), wherein a mixing ratio of the filler to the biodegradable resin in the coating solution falls in a range of filler/biodegradable resin=0.1 to 5.0 in terms of a mass ratio.

The recording material of the present invention elevates an adhesive property between a recording layer and a base material and is excellent in printing characteristics such as a printing aptitude in a heat transfer recording system and an ink jet recording system, particularly an ink jet recording printing aptitude using a solid ink of a pigment base, a writing property and a stamp property, and in addition thereto, it is easily disposed and incinerated.

### BEST MODE FOR CARRYING OUT THE INVENTION

The present invention shall be explained below in details.

The base material used in the present invention has to be crystalline polylactic acid having a biodegradability.

Among them, preferred is a crystalline polylactic acid resin having a mass average molecular weight of usually 10,000 to 1,000,000, preferably 100,000 to 300,000. This crystalline polylactic acid resin is insoluble in general purpose organic solvents.

The polylactic acid resin used for the base material described above may be any one as long as it has a lactic acid structure for a structural unit, and it includes, for example, a resin obtained by subjecting L,D-lactide which is a cyclic dimer of lactic acid to ring-opening polymerization and a resin obtained by subjecting L-lactic acid or D-lactic acid to polycondensation reaction. A material obtained by turning the above resins into a sheet is used for the base material, and the material subjected to stretching treatment in order to elevate a heat stability is suited.

Such polylactic acid resins use lactic acid present in a lot of living being bodies as a raw material and therefore have a degradability by microorganisms. Accordingly, when it is discarded into the environment, it is decomposed by microorganisms present in the nature with the passage of time and turned into resources, and it is finally reduced into water and carbon dioxide. Accordingly, there is no concern that the environment is polluted by the waste.

A thickness of the base material shall not specifically be restricted, and it is usually 10 to 1000 μm, preferably 15 to 500 μm.

The base material comprising the biodegradable resin may be of a single-layer structure or a multilayer structure, and a method for forming the multilayer structure includes, for example, publicly known methods such as a method in which the layers are stuck via an adhesive, a so-called co-extrusion method in which plural raw materials are extruded from plural extruding machines and put together to produce a film and a so-called extrusion laminating method in which films are stuck together and laminated while extruding a film on a film directly from an extruding machine.

Further, one face or both faces of the base material can be subjected, if desired, to surface treatment by an oxidizing method and an irregularity method for the purpose of enhancing the adhesive property with the recording layer and the wetting property.

The oxidizing method described above includes, for example, corona discharge treatment and hot air treatment, and the irregularity method includes, for example, a sand blast method and a solvent treating method. The above surface treating methods are suitably selected according to the kind of the base material, and in general, the corona discharge treating method is preferably used in terms of an effect and an operating property. The surface of the base material can be subjected to easy adhesion treatment.

Next, the biodegradable resin used for the coating solution coated on at least one face of the biodegradable base material described above has to be a non-crystalline polylactic acid. Especially, preferred is a non-crystalline polylactic acid having a weight average molecular weight of 10,000 or more and a softening point of 40 to 110° C. The above non-crystalline polylactic acid has an SP value of 9.5 to 11.5(cal/cm³)^{1/2} and is soluble in the solvent (SP value: 7.5 to 12.5(cal/cm³)^{1/2}) used in the present invention.

In this respect, a method for calculating the SP value shall be described below in details. A lot of methods for calculating the SP value are available, but in the present invention, a method developed by Fedors shall be used. According to it, a solubility parameter ((cal/cm³) 1/2) is represented by the following equation:

$$δ = {( \frac{{\sum }_{i} Δ ei}{{\sum }_{i} Δ vi} )}^{1 / 2}$$

wherein Δei and Δvi each represent an evaporation energy (cal/mole) and a molar volume (cm³/mole)of an atom or an atomic group, provided that in the case of a resin, the following value is added to the molar volume Δvi: in respect to the number n of a principal chain skeleton atom in a minimum repetitive unit of a polymer,
in the case of n<3, 4n(cm³/mole)
in the case of n≧=3, 2n(cm³/mole)
SP value, for example, of methyl ethyl ketone which has two metyl groups, one metylene group and one ketone group is calculated as 9.0(cal/cm³)^{1/2} substituting with following values.
   Δei: 1125*2+1180*1+4150*1=7580 (cal/mole)
   Δvi: 33.5*2+16.1*1+10.8*1=93.9 (cm³/mole)

The copolymer of D-lactic acid and L-lactic acid can be used as the non-crystalline polylactic acid resin. A copolymerization proportion of D-lactic acid to L-lactic acid described above shall not specifically be restricted as long as the resulting non-crystalline polylactic acid resin has a desired molecular weight and a softening point.

L-lactic acid can be obtained at a low cost by lactic acid fermentation, but D-lactic acid is expensive. On the other hand, lactic acid obtained by chemical synthesis is a racemic mixture of D-lactic acid and L-lactic acid, and therefore non-crystalline polylactic acid having a D,L-lactic acid structure can be synthesized at a low cost by adding the above racemic mixture to a raw material for synthesizing the non-crystalline polylactic acid resin. Further, the polylactic acid resin satisfying the conditions described above can be obtained as well by carrying out ring-opening polymerization via L,D-lactide which is a cyclic dimer of lactic acid as described above.

In the recording material of the present invention, the polylactic acid resin has to be used for both of the base material and the recording layer. The combination of the above resins is suited when they are disposed into the natural environment, and they are metabolized by microorganisms present in the natural environment and finally decomposed into water and carbon dioxide.

The solvent dissolving the biodegradable resin comprising the non-crystalline polylactic acid resin described above which is used for the coating solution in the present invention is a solvent having an SP value of 7.5 to 12.5(cal/cm³)^{1/2}; a content of the above solvent in the coating solution is 40 to 90 mass %; and the above solvent has to contain 20 mass % or more of a solvent having a relative dielectric constant of 15 or more. When a mixed solvent obtained by mixing various solvents is used as the solvent, an SP value of the whole mixed solvent has to satisfy the range described above. The solubility is good in an SP value falling in a range of 7.5 to 12.5(cal/cm³)^{1/2}, and a range of 8.5 to 11.5(cal/cm³)^{1/2} is more preferred. The biodegradable resin can homogeneously be dissolved by allowing the SP value and the content to fall in the ranges described above.

The solvent dissolving the biodegradable resin comprising the non-crystalline polylactic acid resin described above which is used for the coating solution in the present invention has to contain 20 mass % or more of a solvent having a relative dielectric constant of 15 or more. The relative dielectric constant is a factor showing relationship between a charge and a force given by it in a material, and it becomes possible to enhance an adhesive property between the recording layer and the base material by adding a fixed amount of the solvent in which the value thereof is 15 or more. It is considered as a factor for enhancing an adhesive property between the recording layer and the base material that the coating solution coated on the base material suitably coarsens the surface layer of the base material. It is considered that a contact area between the recording layer and the base material is increased by coarsening the surface layer of the base material and that the adhesive power is raised. In order to suitably coarsen the surface layer of the base material, the solvent used for the coating solution coated for a recording layer has preferably a high polarity. It is considered that the coating solution adsorbs well on the base material by having a high polarity to swell the surface thereof, whereby suitable coarseness can be provided. A relative dielectric constant is used as a numerical value for measuring a polarity degree of a solvent in the present invention.

When the solvents are used in a mixture, 20 % or more of the whole mixed solvent has to be a solvent having a relative dielectric constant of 15 or more. This makes it possible to exhibit well the polarity described above and raise the adhesive property.

In the present invention, solvents satisfying the requisite described above are used as the solvent for dissolving the resin, and the solvent includes methyl ethyl ketone, acetone and N,N-dimethylforamide and a mixture of these solvent with ethyl acetate and toluene.

In the present invention, in addition to the solvent for dissolving the resin satisfying the requisite described above, a solvent (hereinafter referred to as a retarder solvent) added for inhibiting the solvent for dissolving the above resin from vaporizing can be used. Such retarder solvent includes xylene, ethylene glycol monomethyl ether, ethylene glycol monoethyl ether, diethylene glycol, diethylene glycol monoethyl ether, diethylene glycol monobutyl ether, propylene glycol monoethyl ether, propylene glycol monomethyl ether, butylene glycol monoethyl ether, benzyl alcohol, diethylene glycol monobutyl ether acetate, normal propyl acetate, normal butyl acetate and isoamyl alcohol. Among them, preferred are propylene glycol monomethyl ether, propylene glycol monoethyl ether, butylene glycol monoethyl ether, normal propyl acetate, and normal butyl acetate.

A concentration of the coating solution can be stabilized by using the above retarder solvents, and therefore it becomes possible to finish flatly the surface of the recording layer formed by coating the above coating solution. Further, The layer obtained by coating the coating solution for forming the recording layer can be inhibited from shrinking in a drying step.

An amount of the retarder solvent is preferably 50 mass % or less based on the whole amount of the solvents.

In the present invention, a filler is added to the coating solution together with the biodegradable resin for the purpose of enhancing a strength and a recording characteristic of the recording layer, and thus the recording layer is formed. A mixing ratio of the filler to the biodegradable resin falls in a range of preferably filler/biodegradable resin=0.1 to 5.0, more preferably 0.3 to 4.0 in terms of a mass ratio.

The recording layer is improved in an absorbability of an ink and a strength in the recording layer by allowing a ratio of the filler to the biodegradable resin to fall in the range described above.

A natural inorganic and/or organic filler is used as the filler.

The natural inorganic filler includes, for example, calcium carbonate, talc, clay, kaoline, titanium oxide and silica. The natural inorganic filler has an average particle diameter of preferably 30 μm or less, more preferably 0.1 to 20 μm. The above filler provides the surface layer with suited roughness useful for writing by a pencil and brings about an effect of absorbing water-based and oil-based inks.

The natural inorganic filler is not metabolized by microorganisms present in the natural environment, but it is obtained by subjecting a mineral resource inherently present in the ground to refining treatment to some extent, so that if disposed into the environment and remaining after the resin is decomposed, no problems shall be caused. Accordingly, fillers which are subjected on a surface thereof to specific covering treatment and fillers which are synthesized are not preferred.

Particularly starch base particles and cellulose base particles are excellent as the natural organic filler in terms of a microbial degradability. The starch base particles include, for example, fine powders of rice starch, corn starch and potato starch. The cellulose base particles include fine powders of Tosco hemp cellulose powder and cellulose acetate powder. The above natural organic fillers have an average particle diameter of preferably 50 μm or less, more preferably 1 to 30 μm.

Further, various additives such as a defoaming agent, an antistatic agent, a UV absorber, a fluorescent whitening agent, an antisepticagent, a pigment dispersant, a thickener and the like can be added, if necessary, to the recording layer as long as the object of the present invention is not damaged.

The recording material of the present invention has the recording layer on at least one face of the base material, and the recording layer may be provided on one face of the base material or may be provided on both faces thereof for the purpose of preventing curl. Also, two or more recording layers used in the present invention may be provided on one face of the base material for the purpose of preventing cracks.

Further, layers other than the recording layer may be provided. For example, a layer having a suited opacity may be provided for the purpose of elevating a masking property (masking layer), and a UV-absorbing layer may be provided. Also, a layer for preventing curl may be provided. The biodegradable resin is preferably used for these layers other than the above recording layers.

The above recording layer and other layers may be optionally provided for the recording material of the present invention can be formed in the following manner. These layers can be formed by dispersing or dissolving the needed components in the solvent and coating and drying the coating solution. Publicly known various methods such as reverse roll coating, air knife coating, gravure coating and blade coating can be used for coating.

The recording layer has a thickness (after drying) falling in a range of preferably 0.1 to 80 μm, more preferably 2 to 50 μm. If it is smaller than this range, the ink-absorbing capacity is short, and feathering is liable to be caused. On the other hand, if it is larger than the above range, the recording layer is reduced in a strength in a certain case.

### EXAMPLES

Next, the present invention shall be explained in further details with reference to examples, but the present invention shall by no means be restricted by these examples.

The performances of the recording material were evaluated according to methods shown below.

(1) Setting Property of Oxidation-polymerized Ink

An ink for offset print was printed on a recording material by means of an RI print aptitude tester (manufactured by Akira Seisakusho Co., Ltd.), and it was pressed onto a base paper at a fixed pressure. A transferring state of the ink onto the base paper was observed and visually evaluated as follows. A process ink for synthetic paper (TSP202, manufactured by Toyo Ink MFG Co., Ltd.) was used for the ink.
◯: ink was absorbed immediately
Δ: absorption of ink is a little inferior, but no problems in terms of actual use
X: absorption of ink is very inferior
   (2) Adhesive Property of UV-curing Ink

A UV-curing ink was printed on a recording material by means of the RI print aptitude tester (manufactured by Akira Seisakusho Co., Ltd.), and it was cured by means of a UV ray-irradiating apparatus (manufactured by Eye Graphics Co., Ltd.). Best Cure 161 (manufactured by T & K TOKA Co., Ltd.) was used for the ink. The ink was cured on the irradiating conditions of a metal halide lamp output of 120 W/cm and a line speed of 10 m/minute. In respect to the adhesive property, a peeling test was carried out using a cellophane adhesive tape (manufactured by Nichiban Co., Ltd.) to evaluate the peeling degree of the ink.
◯: the ink of a part on which the cellophane adhesive tape is stuck is scarcely peeled
Δ: the ink is considerably peeled
X: only the ink is completely peeled
   (3) Printing Aptitude in Ink Jet Recording System

An ink jet printer (Tektronix PHASER 850) manufactured by Fuji Xerox Co., Ltd. was used to form a color recording image by solid inks of four color pigments of yellow, magenta, cyan and black.

Immediately after printing the images, a recorded part of the recorded matter was visually observed to evaluate the state of color reproducibility.
◯: clear image is formed
Δ: absorbability of the ink is a little bad, and the image is inferior in a quality
X: flow-out of the ink is observed, and the image is blurred
   (4) Printing Aptitude in Heat Transfer Recording System

A heat transfer printer (Smile Profile N-800II) manufactured by Alps Co., Ltd. was used to form a color recording image by ink ribbons of transfer inks of a resin melt type having four colors of yellow, magenta, cyan and black.

Immediately after printing the images, a recorded part of the recorded matter was visually observed to evaluate the state of color reproducibility.
◯: clear printed letter is formed
Δ: reproducibility of dots is bad, and the printed letter is inferior in a quality
X: dots are not transferred, and letters are scarcely printed
   (5) Writing Property

A pencil (Tombow 8900 2H/H/F/HB/B/2B, manufactured by Tombow Pencil Co., Ltd), a ballpoint pen (Zebra Ballpoint Pen, manufactured by Zebra Co., Ltd), a water-based pen (magic lashon water-based pen, manufactured by Teranishi Chemical Industries Co., Ltd) and an oil-based pen (Tombow oil-based pen, manufactured by Tombow Pencil Co., Ltd) were used for writing to evaluate the writing property.
◯: no feathering and rubbing observed, and clear
Δ: feathering and rubbing caused, but legible
X: feathering and rubbing caused, and illegible
   (6) Stamp Property

Sealing was carried out by a sealing stamp ink (vermilion inkpad Ecos MG50EC, manufactured by Shachihata Inc.), and the above sealed part was rubbed with a finger tip immediately thereafter to evaluate the stamp property.
◯: no feathering observed, and clear
Δ: feathering caused, but legible
X: feathering caused, and illegible
   (7) Adhesive Property

The adhesive property was evaluated by a cross-cut tape method (based on JIS K-5400). Cuts passing through the recording layer and reaching the base material face were provided in a cross-cut form, and a cellophane adhesive tape (No. 405, width 18 mm, manufactured by Nichiban Co., Ltd.) was adhered on the cross-cuts. The cellophane adhesive tape was strongly rubbed five times with a thumb and then quickly peeled off to a direction of 45 degrees to evaluate the adhesive property from a whole square area of a lost part in the recording layer adhered on the cellophane adhesive-tape.
◯: no lost part observed
Δ: area of a lost part is 50% or less
X: area of a lost part exceeds 50%
   (8) Biodegradability

The recording material was buried into a soil in a field, and a degraded area of the recording layer (5 cm×5 cm) was evaluated after 3 months passed.
◯: degraded area is 30% or more
Δ: degraded area is less than 30% and exceeds 0%
X: not degraded at all
   (9) Solubility

Measured were temperature and time which were required for dissolving the resin in the solvent in the compositions of the examples and the comparative examples. A homomixer (T. K. HOMODISPER, manufacture by Tokushu Kika Kogyo Co., Ltd.) was used for stirring.
◯: one hour or shorter at 70° C.
Δ: longer than one hour to 3 hours or shorter at 70° C.
X: not dissolved even after exceeding 3 hours at 70° C.

### Examples 1 to 4 and Comparative Examples 1 to 4

A coating solution having the following composition was coated on one face of a white polylactic acid film (Ecoloju SW201, melting point 160 to 170° C., glass transition temperature 56 to 57° C., manufactured by Mitsubishi Plastics, Inc.) having a thickness of 100 μm which was subjected to corona discharge treatment by means of a gravure coater, and it was dried at 60° C. to form a recording layer having a coated thickness of 8 μm, whereby a recording material was prepared. This recording material was evaluated for performances. The evaluation results thereof are shown in Table 2.

Composition (parts: mass parts)

| | |
|---|---|
| Polylactic acid resin (LACEA H-280, | 8 parts |
| mass average molecular weight: 90000 | |
| to 100000, softening point: 55° C., | |
| non-crystalline resin, manufactured | |
| by Mitsui Chemicals, Inc.) | |
| Solvent or mixed solvent described | 58.7 parts |
| in Table 1 | |
| Retarder solvent: propylene glycol | 28 parts |
| monomethyl ether | |
| Calcium carbonate (precipitated | 0.8 part |
| calcium carbonate light, average | |
| particle diameter: 2.0 μm, | |
| manufactured by Maruo Calcium Co., Ltd.) | |
| Silica (Mizukasil P526, average | 2.4 parts |
| particle diameter: 6.4 μm, manufactured | |
| by Mizusawa Industrial Chemicals, Ltd.) | |
| Titanium oxide (Tipaque R670, | 1.3 part |
| average particle diameter: 0.21 μm, | |
| manufactured by Ishihara Sangyo Kaisha, Ltd.) | |
| Antistatic agent (Cyastat SN, | 0.8 part |
| manufactured by Cytec Industries, Inc.) | |

TABLE 1

| | | Relative | | | | | | | | | | |
|---|---|---|---|---|---|---|---|---|---|---|---|---|
| | | specific | SP | | | | | | | | | |
| | | dielectric | value | Example | | | | Comparative Example | | | | |
| | Kind | constant | (each) | 1 | 2 | 3 | 4 | 1 | 2 | 3 | 4 | 5 |
| Solvent | metyl ethyl | 18 | 9.0 | 100% | | 50% | 30% | | | | | 10% |
| | ketone | | | | | | | | | | | |
| | acetone | 21 | 9.1 | | 100% | | | | | | | |
| | ethyl | 6 | 8.7 | | | 50% | 30% | | 100% | | | 40% |
| | acetate | | | | | | | | | | | |
| | toluene | 2 | 9.1 | | | | 40% | | | 100% | | 50% |
| | cyclohexane | 2 | 4.0 | | | | | 100% | | | | |
| | methanol | 33 | 13.8 | | | | | | | | 100% | |

| | | | | | | | | | |
|---|---|---|---|---|---|---|---|---|---|
| SP value (whole) | 9.0 | 9.1 | 8.9 | 9.0 | 4.0 | 8.7 | 9.1 | 13.8 | 8.8 |

Unit of SP value: (cal/cm³)^{1/2}

TABLE 2

| | | | | | Comparative | | | | |
|---|---|---|---|---|---|---|---|---|---|
| | Example | | | | Example | | | | |
| | 1 | 2 | 3 | 4 | 1 | 2 | 3 | 4 | 5 |
| Setting property of | ◯ | ◯ | ◯ | ◯ | — | ◯ | ◯ | — | ◯ |
| Oxidation-polymerized ink | | | | | | | | | |
| Adhesive property of | ◯ | ◯ | ◯ | ◯ | — | ◯ | ◯ | — | ◯ |
| UV-curing ink | | | | | | | | | |
| Printing aptitude in ink | ◯ | ◯ | ◯ | ◯ | — | Δ | Δ | — | Δ |
| jet recording system | | | | | | | | | |
| Printing aptitude in heat | ◯ | ◯ | ◯ | ◯ | — | Δ | X | — | Δ |
| transfer rocording | | | | | | | | | |
| system | | | | | | | | | |
| Writing property | ◯ | ◯ | ◯ | ◯ | — | ◯ | ◯ | — | ◯ |
| Stamp property | ◯ | ◯ | ◯ | ◯ | — | ◯ | Δ | — | ◯ |
| Adhesive property | ◯ | ◯ | ◯ | ◯ | — | X | X | — | Δ |
| Biodegradability | ◯ | ◯ | ◯ | ◯ | — | ◯ | ◯ | — | ◯ |
| Solubility | ◯ | ◯ | ◯ | ◯ | X | Δ | Δ | X | ◯ |

### INDUSTRIAL APPLICABILITY

The recording material of the present invention is used for identification cars, driver's licenses, commutation tickets, cash cards, ID cards, product display labels (bar cords), labels for advertisement (sticker), general purpose labels, paper for illumination, fabricated products, general commercial printed matters such as posters, calendars and magazines and printed matters for packing such as packing sheets and dressing cases, and in particular, it is suitably used for uses in which the recorded materials are disposed after used for a fixed period, such as affixing a seal with water-based and oil-based stamps, writing with water-based and oil-based ballpoint pens and pencils and printing letters by means of various printers such as a heat transfer printer and an ink jet printer.

1. A recording material having a recording layer formed by coating a coating solution containing a biodegradable resin comprising a non-crystalline polylactic acid resin and a filler on at least one face of a base material comprising a crystalline biodegradable polylactic acid resin, wherein a solvent used for the coating solution is a solvent having a solubility parameter of 7.5 to 12.5(cal/cm³)^{1/2}, and a content of the above solvent in the coating solution is 40 to 90 mass %; and the above solvent contains 20 mass % or more of a solvent having a relative dielectric constant of 15 or more.

2. The recording material as described in claim 1, wherein the filler is a natural inorganic and/or organic filler.

3. The recording material as described in claim 1, wherein a mixing ratio of the filler to the biodegradable resin in the coating solution falls in a range of filler/biodegradable resin=0.1 to 5.0 in terms of a mass ratio.

4. The recording material as described in claim 2, wherein a mixing ratio of the filler to the biodegradable resin in the coating solution falls in a range of filler/biodegradable resin=0.1 to 5.0 in terms of a mass ratio.
